(19) United States
(12) Patent Application Publication
(10) Pub. No.: US 2022/0122369 A1
(43) Pub. Date: Apr. 21, 2022

(54) ULTRASONIC FINGERPRINT MODULE AND MANUFACTURING METHOD THEREOF, AND ELECTRONIC DEVICE

(71) Applicant: JIANGXI OUMAISI MICROELECTRONICS CO., LTD., Nanchang (CN)

(72) Inventors: Xuanxuan LIU, Nanchang (CN); Huangyi ZHU, Nanchang (CN)

(21) Appl. No.: 17/564,282

(22) Filed: Dec. 29, 2021

Related U.S. Application Data
(63) Continuation of application No. PCT/CN2019/114126, filed on Oct. 29, 2019.

(51) Int. Cl. G06V 40/13; C09D 163/00; C09D 7/40; C09D 7/61; C09D 7/47; C08K 3/04

(52) U.S. Cl. CPC G06V 40/1306; G06V 40/1329; C09D 163/00; C08K 2201/005; C09D 7/61; C09D 7/47; C08K 3/04; C09D 7/69

(57) ABSTRACT

An ultrasonic fingerprint module and a manufacturing method thereof, and an electronic device are provided. The ultrasonic fingerprint module includes an ultrasonic detecting layer and an ink layer, the ultrasonic detecting layer has an ultrasonic receiving surface, the ink layer is disposed on a surface of the ultrasonic detecting layer away from the ultrasonic receiving surface, the ink layer is configured to reflect ultrasonic waves emitted from the ultrasonic detecting layer, the ink layer includes a resin material and carbon powder particles, and the carbon powder particles have an average particle size of 0.5 micrometer (μm) to 5 μm and have a mass ratio of 2.5% to 15%.

### CROSS-REFERENCE TO RELATED APPLICATIONS

This application is a continuation of International Application No. PCT/CN2019/114126, filed on Oct. 29, 2019, the entire disclosure of which is incorporated herein by reference.

### TECHNICAL FIELD

This disclosure relates to the technical field of fingerprint recognition, and in particular to an ultrasonic fingerprint module, a manufacturing method of the ultrasonic fingerprint module, and an electronic device.

### BACKGROUND

At present, an ultrasonic fingerprint module recognizes a user's fingerprint, by comparing ultrasonic signals reflected from a user's fingerprint-valley region with ultrasonic signals reflected from a user's fingerprint-ridge region. However, under the condition that ultrasonic signals can easily penetrate through the ultrasonic fingerprint module, intensity of ultrasonic signals obtained by the ultrasonic fingerprint module is reduced, a difference between the ultrasonic signals reflected from the user's fingerprint-valley region and the ultrasonic signals reflected from the user's fingerprint-ridge region is difficult to distinguish, which reduces fingerprint recognition efficiency.

### SUMMARY

An ultrasonic fingerprint module is provided in the present disclosure. The ultrasonic fingerprint module includes an ultrasonic detecting layer and an ink layer. The ultrasonic detecting layer has an ultrasonic receiving surface, the ink layer is disposed on a surface of the ultrasonic detecting layer away from the ultrasonic receiving surface, and the ink layer is configured to reflect ultrasonic waves emitted from the ultrasonic detecting layer. The ink layer includes carbon powder particles which have an average particle size of 0.5 micrometer (μm) to 5 μm and have a mass ratio of 2.5% to 15%.

A manufacturing method of an ultrasonic fingerprint module is further provided in the present disclosure and includes the following operations. An ultrasonic detecting layer is provided, where the ultrasonic detecting layer has an ultrasonic receiving surface and a bottom surface of the ultrasonic detecting layer disposed opposite to the ultrasonic receiving surface. A liquid ink material including carbon powder particles is provided, where the carbon powder particles have an average particle size of 0.5 μm to 5 μm and have a mass ratio of 2.5% to 15%. The liquid ink material is laid on the bottom surface of the ultrasonic detecting layer, where the liquid ink material is cured to form an ink layer, and the ink layer covers the ultrasonic receiving surface of the ultrasonic detecting layer.

An electronic device is further provided in the present disclosure. The electronic device includes the above ultrasonic fingerprint module

### BRIEF DESCRIPTION OF THE DRAWINGS

In order to describe technical solutions of implementations more clearly, the following will give a brief introduction to the accompanying drawings used for describing the implementations. Apparently, the accompanying drawings hereinafter described are some implementations of the disclosure. Based on these drawings, those of ordinary skill in the art can also obtain other drawings without creative effort.

FIG. 1 is a schematic view illustrating an ultrasonic fingerprint module provided in implementations of the present disclosure.

FIG. 2 is a schematic view illustrating an ultrasonic fingerprint module provided in other implementations of the present disclosure.

FIG. 3 is a schematic view illustrating an ultrasonic fingerprint module provided in other implementations of the present disclosure.

FIG. 4 is a schematic flowchart illustrating a manufacturing method of an ultrasonic fingerprint module provided in implementations of the present disclosure.

FIG. 5 is a schematic view illustrating a display screen assembly provided in implementations of the present disclosure.

FIG. 6 is a schematic view illustrating a display screen assembly provided in other implementations of the present disclosure.

FIG. 7 is a schematic view illustrating a display screen assembly provided in other implementations of the present disclosure.

FIG. 8 is a schematic view illustrating a display screen assembly provided in other implementations of the present disclosure.

FIG. 9 is a schematic view illustrating a display screen assembly provided in other implementations of the present disclosure.

FIG. 10 is a schematic view illustrating a display screen assembly provided in other implementations of the present disclosure.

FIG. 11 is a schematic cross-sectional view illustrating an electronic device provided in implementations of the present disclosure.

### DETAILED DESCRIPTION

Technical solutions in implementations of the present disclosure will be described clearly and completely hereinafter with reference to the accompanying drawings in the implementations of the present disclosure.

A purpose of the present disclosure is to provide an ultrasonic fingerprint recognition module, a manufacturing method of the ultrasonic fingerprint module, and an electronic device, which can improve fingerprint recognition efficiency.

An ultrasonic fingerprint module is provided in the present disclosure. The ultrasonic fingerprint module includes an ultrasonic detecting layer and an ink layer. The ultrasonic detecting layer has an ultrasonic receiving surface, the ink layer is disposed on a surface of the ultrasonic detecting layer away from the ultrasonic receiving surface, and the ink layer is configured to reflect ultrasonic waves emitted from the ultrasonic detecting layer. The ink layer includes carbon powder particles which have an average particle size of 0.5 micrometer (μm) to 5 μm and have a mass ratio of 2.5% to 15%. The ink layer is configured to reflect the ultrasonic waves emitted from the ultrasonic detecting layer to a fingerprint to be detected, such that ultrasonic signals received by the fingerprint to be detected are strengthened. In addition, the carbon powder particles in the ink layer are set to have the average particle size of 0.5 μm to 5 μm and have the mass ratio of 2.5% and 15%, such that surface roughness of the ink layer can be effectively reduced, reflection uniformity of the ink layer to ultrasonic signals can be improved, and clearer fingerprint images can be obtained by the ultrasonic fingerprint module.

The carbon powder particles have the average particle size of 0.8 μm to 2 μm, furthermore, 1.0 μm, such that roughness of the ink layer can be further reduced.

The carbon powder particles have the mass ratio of 3.0% to 10% in the ink layer, such that the roughness of the ink layer can be further reduced.

The carbon powder particles have the mass ratio of 5% in the ink layer, which can ensure that the roughness of the ink layer is reduced, and reduce production costs of the ink layer.

The ink layer includes a resin material, which ensures that the ink layer can play an insulating and protecting role on the ultrasonic detecting layer. In addition, a cured resin material has an elastic modulus similar to a plastic sheet, which ensures that the ink layer has an ultrasonic refection efficiency substantially the same as the plastic sheet.

The resin material includes any one of or a combination of more than one of: acrylic resin, polyester resin, isocyanate resin, phenoxy resin, and epoxy resin, such that material selection of the ink layer can be diversified.

The resin material is epoxy resin with a chemical abstracts service (CAS) number of 38891-59-7, which further improves fingerprint recognition accuracy of the ultrasonic fingerprint module.

The ink layer is provided with a leveling agent, and the leveling agent is configured to improve a surface leveling property of the ink layer during a manufacturing process and improve the surface leveling property of a finally formed ink layer. The leveling agent has great performance in eliminating bubbles on a surface of the ink layer, smoothness control of the surface of the ink layer, and improving the surface leveling property of the ink layer, such that the surface roughness of the ink layer can be effectively reduced.

The ink layer is provided with an anti-foaming agent, and the anti-foaming agent is configured to eliminate bubbles in the ink layer during the manufacturing process and eliminate bubbles in the finally formed ink layer. The anti-foaming agent has performance in eliminating bubbles generated in the ink layer during the manufacturing process, such that the number of bubbles in the ink layer can be reduced, thereby improving definition of a fingerprint image obtained by the ultrasonic fingerprint module.

The ultrasonic detecting layer includes a substrate layer, a pixel electrode layer, a piezoelectric layer, and a conductive electrode which are stacked in sequence, and the ink layer is disposed on a surface of the conductive electrode away from the piezoelectric layer, which makes the ultrasonic fingerprint module thinner, and facilitates integration of the ultrasonic fingerprint module into a display screen of the electronic device.

The ink layer has a thickness of 5 μm to 30 μm, such that the surface roughness of the ink layer is effectively reduced, and definition of the fingerprint image obtained by the ultrasonic fingerprint module is effectively improved.

The ink layer has the thickness of 20 μm to 30 μm, such that the surface roughness of the ink layer is further reduced, and the definition of the fingerprint image obtained by the ultrasonic fingerprint module is further improved.

The ink layer has the thickness of 25 μm, such that the surface roughness of the ink layer is further reduced, and a signal noise ratio (SNR) value and a line pairs per millimeter (LPMM) value of the ultrasonic fingerprint module are optimized.

A manufacturing method of an ultrasonic fingerprint module is further provided in the present disclosure and includes the following operations. An ultrasonic detecting layer is provided, where the ultrasonic detecting layer has an ultrasonic receiving surface and a bottom surface of the ultrasonic detecting layer disposed opposite to the ultrasonic receiving surface. A liquid ink material including carbon powder particles is provided, where the carbon powder particles have an average particle size of 0.5 μm to 5 μm and have a mass ratio of 2.5% to 15%. The liquid ink material is laid on the bottom surface of the ultrasonic detecting layer, where the liquid ink material is cured to form an ink layer, and the ink layer covers the ultrasonic receiving surface of the ultrasonic detecting layer. By laying the liquid ink material on the bottom surface of the ultrasonic detecting layer, the ink layer with large area is easy to mold, such that an ultrasonic fingerprint module with large area can be obtained, thereby increasing area of a fingerprint recognition region of the ultrasonic fingerprint module.

The liquid ink material further includes a resin material, a leveling agent, and an anti-foaming agent, and the liquid ink material is formed by mixing and stirring the resin material, the carbon powder particles, the leveling agent, and the anti-foaming agent, such that the surface roughness of the ink layer is reduced, there are no bubbles in the ink layer, thereby improving reflection uniformity of the ink layer to ultrasonic signals, and further improve fingerprint recognition efficiency of the ultrasonic fingerprint module.

During providing the ultrasonic detecting layer, a substrate layer, a pixel electrode, a piezoelectric layer, and a conductive electrode are molded and stacked in sequence, and a surface of the conductive electrode away from the piezoelectric layer forms the bottom surface of the ultrasonic detecting layer, which makes the ultrasonic fingerprint module thinner, and facilitates integration of the ultrasonic fingerprint module into a display screen of the electronic device.

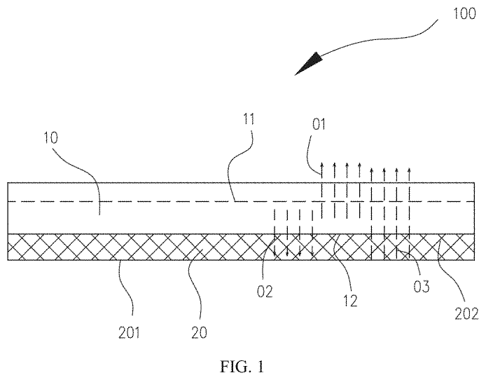

An electronic device is further provided in the present disclosure. The electronic device includes the above ultrasonic fingerprint module, such that the electronic device can meet diversified fingerprint recognition requirements, and the fingerprint recognition efficiency can be improved. Reference can be made to FIG. 1, and an ultrasonic fingerprint module 100 is provided in the disclosure. The ultrasonic fingerprint module 100 includes an ultrasonic detecting layer 10 and an ink layer 20. The ultrasonic detecting layer 10 includes an ultrasonic receiving surface 11, and the ink layer 20 is molded on a surface of the ultrasonic detecting layer 10 away from the ultrasonic receiving surface 11. The ink layer 20 can be configured to prevent ultrasonic waves from being emitted out from a surface away from the ultrasonic detecting layer 10, and reflect ultrasonic signals propagated from the ultrasonic detecting layer 10 to the ultrasonic detecting layer 10.

It can be understood that, the ultrasonic fingerprint module 100 can be configured to detect a user's fingerprint through ultrasonic signals to recognize a user's fingerprint image. The ultrasonic fingerprint module 100 can be applicable to an electronic device, and the electronic device may be a mobile phone, a tablet computer, a notebook computer, a media player, etc., or a financial terminal device such as an automated teller machine (ATM).

The ink layer 20 is disposed on the ultrasonic detecting layer 10 of the ultrasonic fingerprint module 100, and the ink layer 20 can be configured to block and reflect the ultrasonic signals, such that ultrasonic signals received by the ultrasonic detecting layer 10 can be strengthened, thereby improving ultrasonic-signal receiving efficiency of the ultrasonic detecting layer 10, and improving fingerprint recognition efficiency.

In this implementation, the ultrasonic detecting layer 10 can emit ultrasonic signals and sense the ultrasonic signals to recognize the user's fingerprint. The ultrasonic detecting layer 10 can emit first ultrasonic signals 01 toward a side away from the ink layer 20 and emit second ultrasonic signals 02 toward the ink layer 20. When the ultrasonic fingerprint module 100 is applicable to the electronic device, once a user's finger is moving close to a side of the ultrasonic fingerprint module 100 away from the ink layer 20, the first ultrasonic signals 01 are emitted toward the user's fingerprint, the second ultrasonic signals 02 are blocked by the ink layer 20 and reflected toward the ultrasonic detecting layer 10 to form third ultrasonic signals 03. The third ultrasonic signals 03 are also emitted toward the use's fingerprint. After resonating, the third ultrasonic signals 03 and the first ultrasonic signals 01 can be emitted toward the user's fingerprint together.

It can be understood that, after receiving resonant ultrasonic signals, the user's fingerprint reflects the resonant ultrasonic signals back to the ultrasonic detecting layer 10, such that fingerprint detecting signals sensed by the ultrasonic detecting layer 10 are enhanced. The ultrasonic detecting layer 10 receives ultrasonic detecting signals through the ultrasonic receiving surface 11 to obtain the user's fingerprint image. Because the user's fingerprint has a ridge region and a valley region which have different reflectivity to ultrasonic initial signals, the ultrasonic detecting signals reflected by the user's fingerprint include ridge signals that can indicate the ridge region and include valley signals that can indicate the valley region. The ridge signals are compared with the valley signals, difference data between the ridge signals and the valley signals are obtained to be processed, such that the user's fingerprint image is obtained.

In this implementation, the ultrasonic detecting layer 10 substantially forms a fingerprint recognition region in a region covered by the ultrasonic fingerprint module 100. The ultrasonic fingerprint module 100 adopts the ultrasonic detecting layer 10 with large area, such that the fingerprint recognition region of the ultrasonic fingerprint module 100 may have a length dimension of 30 millimeters (mm) and have a width dimension of 20 mm. Compared with a current fingerprint module with small fingerprint recognition area, the ultrasonic fingerprint module 100 has larger fingerprint recognition area and can be applicable to a large-area fingerprint unlocking scene, fingerprint blind unlocking can be realized, and it is convenient to control applications of the electronic device to launch through fingerprints unlocking. For example, the ultrasonic fingerprint module 100 is more applicable to a full screen mobile phone to meet a need of large-area fingerprint recognition. Of course, in other implementations, the fingerprint recognition region of the ultrasonic fingerprint module 100 may have the length dimension of 40 mm or more and may have the width dimension of 30 mm or more.

In this implementation, since the fingerprint recognition region of the fingerprint recognition module 100 increases, area of an ultrasonic detecting layer 10 increases. The ink layer 20 can be molded on the ultrasonic detecting layer 10 by adopting a printing process, a vacuum evaporation process, a spraying process, or other large-area processing processes, to prevent bubbles from being generated at an interface between the ink layer 20 and the ultrasonic detecting layer 10, and avoid uneven ultrasonic reflection efficiency caused by the bubbles, thereby ensuring effectiveness of fingerprint recognition. The ink layer 20 may be an insulating ink. A surface of the ink layer 20 away from the ultrasonic detecting layer 10 is in contact with air, and an interface between the ink layer 20 and air forms an ultrasonic reflection surface. There is a difference between acoustic impedance of the ink layer 20 and acoustic impedance of air, and when the difference is greater, ultrasonic reflectivity of the interface between the ink layer 20 and air is higher. The acoustic impedance of the ink layer 20 is in direct proportion to an elastic modulus of the ink layer 20, therefore when the elastic modulus of the ink layer 20 is greater, the acoustic impedance of the ink layer 20 is greater. In this implementation, the elastic modulus of the ink layer 20 is set to be substantially the same as that of the plastic sheet, such that the ink layer 20 has a great shielding effect on ultrasonic signals, and the interface between the ink layer 20 and air has a great reflection efficiency on ultrasonic signals. The ink layer 20 is configured to resist and reflect ultrasonic signals emitted by the ultrasonic detecting layer 10, such that ultrasonic waves received by the user's fingerprint are strengthened, the ultrasonic detecting layer 10 receives intensive ultrasonic waves reflected from the user's fingerprint, and recognition efficiency of the ultrasonic detecting layer 10 is improved. The ink layer 20 also plays a role in protecting the ultrasonic detecting layer 10 to ensure safety of the ultrasonic detecting layer 10. The ink layer 20 also has performance of resisting ultrasonic waves propagated from external air, so as to resist ultrasonic signals in an external environment, prevent environmental ultrasonic waves from interfering with the ultrasonic detecting layer 10 in recognizing ultrasonic waves reflected from the user's fingerprint, and ensure accuracy of the ultrasonic detecting layer 10 in recognizing the user's fingerprint.

It can be understood that, the ink layer 20 includes a resin material, for example, the ink layer 20 includes any one of or a combination of more than one of: acrylic resin, polyester resin, isocyanate resin, phenoxy resin, and epoxy resin. As a preferable implementation, the ink layer 20 includes epoxy resin. The insulation of the resin material ensures that the ink layer 20 can play a role in insulating and protecting the ultrasonic detecting layer 10. In addition, an elastic modulus of a cured resin material is similar to that of the plastic sheet, which ensures that ultrasonic reflection efficiency of the ink layer 20 is substantially the same as that of the plastic sheet.

In a process of selecting materials of the ink layer 20, multiple ink layers 20 with various materials can be molded on multiple groups of ultrasonic detecting layers 10 through a screen printing process, so as to obtain multiple groups of samples of ultrasonic fingerprint modules 100. By detecting signal noise ratio (SNR) values of the multiple groups of samples of ultrasonic fingerprint modules 100, multiple groups of SNR average values of the multiple groups of samples of ultrasonic fingerprint modules 100 are obtained, and then a material of ink layer 20 with an optimized SNR average value is selected after comparing the multiple groups of SNR average values. The SNR values can be tested by an ultrasonic fingerprint tester.

Specifically, a first group of samples of ultrasonic fingerprint modules 100 are provided, and ink layers 20 of the first group of samples adopt acrylic resin. A second group of samples of ultrasonic fingerprint modules 100 are provided, and ink layers 20 of the second group of samples adopt polyester resin. A third group of samples of ultrasonic fingerprint modules 100 are provided, and ink layers 20 of the third group of samples adopt a mixed resin of acrylic resin, isocyanate resin, and polyester resin. A fourth group of samples of ultrasonic fingerprint modules 100 are provided, and ink layers 20 of the fourth group of samples adopt phenoxy resin. A fifth group of samples of ultrasonic fingerprint modules 100 are provided, ink layers 20 of the fifth group of samples adopt epoxy resin 1, and epoxy resin 1 may be conventional epoxy resin. A sixth group of samples of ultrasonic fingerprint modules 100 are provided, ink layers 20 of the sixth group of samples adopt epoxy resin 2, a specification of epoxy resin 2 is different from that of epoxy resin 1, and epoxy resin 2 has a chemical abstracts service (CAS) number of 38891-59-7. The SNR average values of the first, the second, the third, the fourth, the fifth, and the sixth group of samples are 8.10, 3.77, 7.38, 8.54, 8.89, and 10.33 respectively. The SNR values of the first group of samples are 8.10, 8.75, 8.85, 7.48, 7.45, 7.89, and 8.16 respectively. The SNR values of the second group of samples are 3.77, 3.89, 3.87, 3.22, 3.93, 4.08, and 3.61 respectively. The SNR values of the third group of samples are 7.38, 8.18, 7.09, 7.75, 7.39, 6.84, and 7.02 respectively. The SNR values of the fourth group of samples are 8.54, 8.65, 9.01, 8.76, 7.68, 8.68, and 8.46 respectively. The SNR values of the fifth group of samples are 8.89, 8.89, 8.33, 8.07, 9.69, 8.94, and 9.40 respectively. The SNR values of the sixth group of samples are 10.33, 9.63, 10.47, 10.99, 10.56, 10.03, and 10.32 respectively. Therefore, the SNR average values of the first, the second, the third, the fourth, the fifth, and the sixth group of samples are 8.10, 3.77, 7.38, 8.54, 8.89, and 10.33 respectively. It can be seen that, the sixth group of samples of which the ink layers 20 adopt epoxy resin 2 have a best SNR average value. Therefore, by selecting epoxy resin 2 as the material of the ink layer 20, the ultrasonic fingerprint module 100 can have great fingerprint recognition efficiency. A difference between epoxy resin 1 and epoxy resin 2 lies in specifications. Specifically, the CAS number of epoxy resin 2 is 38891-59-7.

The ultrasonic detecting layer 10 has a bottom surface of the ultrasonic detecting layer 12 opposite to the ultrasonic receiving surface 11, and the ink layer 20 is molded on the bottom surface of the ultrasonic detecting layer 12 through the printing process. The ink layer 20 can be molded on the bottom surface of the ultrasonic detecting layer 12 through a printing process of a thin film transistor (TFT). The ink layer 20 can be molded through the printing process, such that the ink layer 20 can be molded with large area. Multiple ultrasonic fingerprint modules 100 are printed and molded at one time, and ultrasonic fingerprint modules 100 are obtained in batches after cutting, such that production efficiency is improved. Specifically, the ultrasonic detecting layer 10 with large area is molded at first, then the ink layer 20 with large area is printed and molded on the ultrasonic detecting layer 10 with large area, then the ultrasonic detecting layer 10 with large area and the ink layer 20 with large area are cut together to form the multiple ultrasonic fingerprint modules 100, such that rapid mass production of the ultrasonic fingerprint module 100 is realized, production costs are reduced, and efficiency is improved.

In addition, by adding carbon powder particles to the resin material, the ink layer 20 presents an effect of black appearance.

In this implementation, the resin material and carbon powder are mixed to form liquid ink, the liquid ink is molded on the ultrasonic detecting layer 10 through the screen printing process, and then the liquid ink is cured to form the ink layer 20. The elastic modulus of the ink layer 20 is determined according to frequency of ultrasonic waves emitted from the ultrasonic detecting layer 10, such that the elastic modulus of the ink layer 20 matches the frequency of ultrasonic waves. By setting the elastic modulus of the ink layer 20, the ink layer 20 can resist and reflect ultrasonic signals, such that the fingerprint recognition efficiency of the ultrasonic fingerprint module 100 is improved. Because the ink layer 20 includes black carbon powder, the ink layer 20 presents a visual effect of black appearance, and the ink layer 20 can block penetration of visible light. That is, the ink layer 20 can cover the ultrasonic detecting layer 10, such that an appearance defect of the ultrasonic detecting layer 10 is invisible, and appearance performance of the ultrasonic fingerprint module 100 is improved. The ink layer 20 can be molded by printing a liquid printing material to mold a layer structure and performing a curing process on the layer structure. Specifically, firstly, a liquid resin material and black carbon powder material to be mixed with the liquid resin material are provided. Then, a liquid resin material mixed with the black carbon powder material is printed and molded on the bottom surface of the ultrasonic detecting layer 12 of the ultrasonic detecting layer 10 through a printing device. Finally, a liquid ink layer 20 with layer structure is cured to obtain a solid ink layer 20. Of course, in other implementations, the ink layer 20 may also be composed of an insulating adhesive and white carbon powder, or red carbon powder, or green carbon powder to be mixed with the insulating adhesive. The ink layer 20 may also be composed of other materials with ultrasonic shielding performance and mixed with colored particles. Of course, in other implementations, the ink layer 20 may also be a transparent layer, which facilitates integration of the ultrasonic fingerprint module 100 into the display screen, and ensures a display effect of the display screen.

In this implementation, the carbon powder particles in the ink layer 20 can fill gaps between resin particles in the resin material, such that surface roughness of the ink layer 20 is reduced, and a surface of the ink layer 20 is smooth.

Specifically, the ink layer 20 has a first surface 201 away from the ultrasonic detecting layer 10. The first surface 201 is in contact with air. The first surface 201 is smooth, and roughness of the first surface 201 is 0.2 Rz/μm (ten-point height unevenness of profile/μm) to 6.0 Rz/μm. For example, the roughness of the first surface 201 may be 0.41 Rz/μm, 0.68 Rz/μm, 4.76 Rz/μm, or 5.25 Rz/μm. The ink layer 20 has a second surface 202 opposite to the first surface 201. The second surface 202 is attached to the ultrasonic detecting layer 10. The second surface 202 is smooth, and the roughness of the second surface 202 is 0.2 Rz/μm to 6.0 Rz/μm. For example, the roughness of the first surface 201 may be 0.41 Rz/μm, 0.68 Rz/μm, 4.76 Rz/μm, or 5.25 Rz/μm. When the roughness of the first surface 201 is lower, unevenness of the first surface 201 is lower, that is, when the first surface is smoother, it is more difficult for ultrasonic waves to generate diffuse reflection on the first surface 201; when reflection directions of ultrasonic waves on the first surface 201 are more consistent, ultrasonic interference signals received by the ultrasonic detecting layer 10 are smaller, which improves fingerprint recognition definition of the ultrasonic fingerprint module 100. Similarly, when the roughness of the second surface 202 is lower, it is more difficult for ultrasonic waves to generate the diffuse reflection when passing through the second surface 202, which improves the fingerprint recognition efficiency of the ultrasonic fingerprint module 100.

It can be understood that, when the average particle size of the carbon powder particles in the ink layer 20 is larger, it is easier to increase the roughness of the first surface 201 of the ink layer 20 and the roughness of the second surface 202 of the ink layer 20, it is easier for ultrasonic waves to generate diffuse reflection on the first surface 201, and it is easier for ultrasonic waves to generate diffuse reflection on the second surface 202. Therefore, by setting the average particle size of the carbon powder particles in the ink layer 20 and a proportion of the carbon powder particles in the ink layer 20, the roughness of the first surface 201 and the roughness of the second surface 202 can be improved.

In this implementation, the carbon powder particles in the ink layer 20 have the average particle size of 0.5 μm to 5 μm. When the carbon powder particles in the ink layer 20 have the average particle size of 0.5 μm, the ink layer 20 can have minimum roughness, but the ultrasonic fingerprint module 100 does not have an optimum optical density (OD) value. When the carbon powder particles in the ink layer 20 have the average particle size of 5 μm, the ultrasonic fingerprint module 100 has an excellent OD value, but the ink layer 20 does not have optimum roughness. As a preferable implementation, the carbon powder particles in the ink layer 20 have the average particle size of 0.8 μm to 2 μm, particularly 1.0 μm. It can be understood that, when the carbon powder particles in the ink layer 20 have the average particle size of 0.8 μm, the ink layer 20 can have the roughness close to the minimum value, and the ultrasonic fingerprint module 100 can have the OD value meeting performance requirements. When the carbon powder particles in the ink layer 20 have the average particle size of 2 μm, the ultrasonic fingerprint module 100 has an excellent OD value, and the roughness of the ink layer 20 can also be reduced. Furthermore, when the carbon powder particles in the ink layer 20 have the average particle size of 1 μm, the ink layer 20 can have the roughness close to the minimum value, and the ultrasonic fingerprint module 100 can have excellent OD value and SNR value. Of course, the carbon powder particles in the ink layer 20 may also have the average particle size of approximate 1 μm, the ink layer 20 may have the roughness close to the minimum value, and the ultrasonic fingerprint module 100 may also have excellent OD value and SNR value.

In this implementation, the carbon powder particles have a mass ratio of 2.5% to 15% in the ink layer 20. When the carbon powder particles have the mass ratio of 2.5% in the ink layer 20, the ink layer 20 can have minimum roughness, but the ultrasonic fingerprint module 100 does not have an optimal OD value. When the carbon powder particles have the mass ratio of 15% in the ink layer 20, the ultrasonic fingerprint module 100 has a great OD value, but the ink layer 20 does not have minimum roughness. As a preferable implementation, the carbon powder particles have the mass ratio of 3.0% to 10% in the ink layer, particularly 5%. It can be understood that, when the carbon powder particles have the mass ratio of 3.0% in the ink layer 20, the ink layer 20 can have the roughness close to the minimum value, and the ultrasonic fingerprint module 100 can have the OD value meeting the performance requirements. When the carbon powder particles have the mass ratio of 10% in the ink layer 20, the ultrasonic fingerprint module 100 can have the OD value meeting requirements, and the roughness of the ink layer 20 can also be reduced. Furthermore, when the carbon powder particles have the mass ratio of 5% in the ink layer 20, the ink layer 20 can have the roughness close to the minimum value, and the ultrasonic fingerprint module 100 can have excellent OD value and SNR value. Of course, the carbon powder particles may also have the mass ratio of approximate 5% in the ink layer 20, the ink layer 20 may have the roughness close to the minimum value, and the ultrasonic fingerprint module 100 may also have excellent OD value and SNR value.

In order to further improve the roughness of the first surface 201 and the roughness of the second surface 202, a leveling agent is added in a preparation process of the ink layer 20. The leveling agent has great performance in eliminating bubbles on a surface, smoothness control of a surface, and improving a surface leveling property, such that the surface roughness of the ink layer 20 is effectively reduced. That is, the ink layer 20 also includes the leveling agent, and the leveling agent is configured to improve a leveling property of an ink layer 20 in a manufacturing process and a finally formed ink layer. The leveling agent may have the mass ratio of 0.2% to 1.5% in the ink layer 20. The leveling agent may be a fluorocarbon leveling agent, and may be fluorocarbon organic modified siloxane. The leveling agent may also be polyether siloxane copolymer. As a preferable implementation, the leveling agent may be a mixture of fluorocarbon organic modified siloxane and polyether siloxane copolymer. Fluorocarbon organic modified siloxane may have the mass ratio of 0.1% to 0.75%, and polyether siloxane copolymer may have the mass ratio 0.1% to 0.75%. When fluorocarbon organic modified siloxane has the mass ratio of 5% and polyether siloxane copolymer has the mass ratio of 5%, polyether siloxane copolymer and fluorocarbon siloxane have great complementarity, and polyether siloxane copolymer has a strong surface-state control ability, a great surface leveling property, and a certain effect of eliminating bubbles. The ink layer 20 has a great leveling property, a smooth surface, the surface roughness which can be controlled to be less than 0.5 Rz/μm, such that the fingerprint recognition efficiency of the ultrasonic fingerprint module 100 is improved.

A first implementation is provided, in the ink layer 20, the carbon powder particles with 50% particle size distribution have the average particle size of 5 μm. The carbon powder has the mass ratio of 15% in the ink layer 20. The leveling agent in the ink layer 20 adopts fluorocarbon organic modified siloxane. The leveling agent has the mass ratio of 0.2% in the ink layer 20. The ink layer 20 of the ultrasonic fingerprint module 100 in this implementation is tested for the roughness by a roughness tester, and a test result shows that the ink layer 20 has the roughness of 5.25 Rz/μm. The ultrasonic fingerprint module 100 in this implementation is tested for a SNR value by an ultrasonic fingerprint function tester, and an obtained SNR value is 9.45. The ultrasonic fingerprint module 100 in this implementation is tested for an OD value by an optical densitometer, and an obtained OD value is 6.1.

A second implementation is provided, which is different from the first implementation in that the mass ratio of the carbon powder in the ink layer 20 is reduced. In the ink layer 20, the carbon powder particles with 50% particle size distribution have the average particle size of 5 μm. The carbon powder has the mass ratio of 10% in the ink layer 20. The leveling agent in the ink layer 20 adopts fluorocarbon organic modified siloxane. The leveling agent has the mass ratio of 0.2% in the ink layer 20. The ink layer 20 has the roughness of 5.04 Rz/μm. The ultrasonic fingerprint module 100 has the SNR value of 9.52 and has the OD value of 5.3. It can be seen that, by reducing the mass ratio of the carbon powder in the ink layer 20, the surface roughness of the ink layer 20 can be reduced.

It can be understood that, when the OD value of the ultrasonic fingerprint module 100 is greater than 4, the ultrasonic fingerprint module 100 has great performance.

A third implementation is provided, which is different from the second implementation in that the mass ratio of carbon powder in the ink layer 20 is further reduced. In the ink layer 20, the carbon powder particles with 50% particle size distribution have the average particle of 5 μm. The carbon powder has the mass ratio of 5% in the ink layer 20. The leveling agent in the ink layer 20 adopts fluorocarbon organic modified siloxane. The leveling agent has the mass ratio of 0.2% in the ink layer 20. The ink layer 20 has the roughness of 4.76 Rz/μm. The ultrasonic fingerprint module 100 has the SNR value of 9.65 and has the OD value of 4.6. It can be seen that, by reducing the mass ratio of carbon powder in the ink layer 20, the surface roughness of the ink layer 20 can be reduced and the SNR value of the ultrasonic fingerprint module 100 can be improved, however, the OD value of the ultrasonic fingerprint module 100 can be also reduced.

The fourth implementation is provided, which is different from the second implementation in that the mass ratio of carbon powder in the ink layer 20 is further reduced. In the ink layer 20, the carbon powder particles with 50% particle size distribution have the average particle of 5 μm. The carbon powder has the mass ratio of 2.5% in the ink layer 20. The leveling agent in the ink layer 20 adopts fluorocarbon organic modified siloxane. The leveling agent has the mass ratio of 0.2% in the ink layer 20. The ink layer 20 has the roughness of 4.42 Rz/μm. The ultrasonic fingerprint module 100 has the SNR value of 9.7 and has the OD value of 3.7. It can be seen that, when the mass ratio of carbon powder in the ink layer 20 is reduced to 2.5%, the OD value of the ultrasonic fingerprint module 100 is also reduced to 3.7, and the ultrasonic fingerprint module 100 can no longer meet great performance requirements.

A fifth implementation is provided, which is different from the fourth implementation in that the average particle size of the carbon powder in the ink layer 20 is reduced. In the ink layer 20, the carbon powder particles with 50% particle size distribution have the average particle of 0.5 μm, and the carbon powder particles with 100% particle size distribution have an average particle size less than 1 μm. The carbon powder has the mass ratio of 5% in the ink layer 20. The leveling agent in the ink layer 20 adopts fluorocarbon organic modified siloxane. The leveling agent has the mass ratio of 0.2% in the ink layer 20. The ink layer 20 has the roughness of 0.82 Rz/μm. The ultrasonic fingerprint module 100 has the SNR value of 10.25 and has the OD value of 4.3. It can be seen that, when the average particle size of carbon powder in the ink layer 20 is reduced, the surface roughness of the ink layer 20 can be obviously reduced, and it can be ensured that the SNR value of the ultrasonic fingerprint module 100 is great, and the OD value of the ultrasonic fingerprint module 100 also meets the great performance requirements, that is, performance of the ultrasonic fingerprint module 100 is obviously improved.

A sixth implementation is provided, which is different from the fifth implementation in that the mass ratio of the leveling agent in the ink layer 20 is increased. In the ink layer 20, the carbon powder particles with 50% particle size distribution have the average particle of 0.5 μm, and the carbon powder particles with 100% particle size distribution have an average particle size less than 1 μm. The carbon powder has the mass ratio of 5% in the ink layer 20. The leveling agent in the ink layer 20 adopts fluorocarbon organic modified siloxane. The leveling agent has the mass ratio of 0.7% in the ink layer 20. The ink layer 20 has the roughness of 0.68 Rz/μm. The ultrasonic fingerprint module 100 has the SNR value of 10.35 and has the OD value of 4.4. It can be seen that, when the mass ratio of the leveling agent in the ink layer 20 is increased, the surface roughness of the ink layer 20 is reduced, the SNR value of the ultrasonic fingerprint module 100 is increased, and the OD value of the ultrasonic fingerprint module 100 is also increased.

A seventh implementation is provided, which is different from the sixth implementation in that the leveling agent in the ink layer 20 is a mixture of two different types of leveling agents. Specifically, In the ink layer 20, the carbon powder particles with 50% particle size distribution have the average particle of 0.5 μm, and the carbon powder particles with 100% particle size distribution have an average particle size less than 1 μm. The carbon powder has the mass ratio of 5% in the ink layer 20. The leveling agent in the ink layer 20 adopts a mixed leveling agent of fluorocarbon organic modified siloxane and polyether siloxane copolymer. Fluorocarbon organic modified siloxane has the mass ratio of 0.5% in the ink layer 20. Polyether siloxane copolymer has the mass ratio of 0.5% in the ink layer 20. The ink layer 20 has the roughness of 0.41 Rz/μm. The ultrasonic fingerprint module 100 has the SNR value of 10.55 and has the OD value of 4.3. It can be seen that, fluorocarbon organic modified siloxane belongs to the fluorocarbon leveling agent, which has great substrate wettability and strong anti-cratering ability, but this leveling agent is easy to stabilize foam and the foam is difficult to disappear. After adding various leveling agents into a molding material of the ink layer 20, it is found that polyether siloxane copolymer and fluorocarbon siloxane have the great complementarity, and polyether siloxane copolymer has the strong surface-state control ability, the great surface leveling property, and the certain effect of eliminating bubbles. After adding polyether siloxane copolymer and fluorocarbon siloxane into the molding material of the ink layer 20, the leveling property is great, the surface is smooth, and the surface roughness of the ink layer 20 can be controlled to be less than 0.5 RZ/μm.

It can be understood that, if there are bubbles in the ink layer 20, because the bubbles have less ultrasonic acoustic impedance, a signal intensity is greatly attenuated or even attenuated to zero when ultrasonic signals penetrates through the bubbles and are reflected by the bubbles, that is, received signal intensities of the ultrasonic detecting layer 10 at positions corresponding to the bubbles in the ink layer 20 are quite different from that at other regions, such that an obtained fingerprint image has noise, i.e., the obtained fingerprint image is not clear. Therefore, by reducing the bubbles in the ink layer 20, the definition of the fingerprint image obtained by the ultrasonic fingerprint module 100 can be improved.

In order to further reduce the number of bubbles in the ink layer 20, the anti-foaming agent is added into the molding material of the ink layer 20, such that the number of bubbles in the ink layer 20 can be reduced with the aid of anti-foaming performance of the anti-foaming agent. That is, the ink layer 20 further includes the anti-foaming agent, which is configured to eliminate bubbles in the ink layer during a manufacturing process and eliminate bubbles in a finally formed ink layer. The anti-foaming agent may have the mass ratio of 1.0% to 3.0% in the ink layer 20. The anti-foaming agent may be modified dimethyl silane, or polyoxypropylene oxyethylene glycerol ether. As a preferable implementation, the anti-foaming agent may be a mixture of modified dimethyl silane and polyoxypropylene oxyethylene glycerol ether. Modified dimethyl silane may have the mass ratio of 0.8% to 2.0%, and polyoxypropylene oxyethylene glycerol ether may have the mass ratio of 0.2% to 1.0%. When fluorocarbon organic modified siloxane has the mass ratio of 1.5% and polyether siloxane copolymer has the mass ratio of 0.5% to 1.0%, there are no bubbles in the ink layer 20.

An eighth implementation is provided, the ink layer 20 includes the anti-foaming agent. Specifically, the carbon powder has the mass ratio of 15% in the ink layer 20. The anti-foaming agent in the ink layer 20 is modified dimethyl silane. The anti-foaming agent has the mass ratio of 0.5% in the ink layer 20. After the molding material of the ink layer 20 with the anti-foaming agent added is stirred, there are a large number of bubbles. After stirred molding material of the ink layer 20 is printed and molded on the ultrasonic detecting layer 10 through the screen printing process, there are still a large number of bubbles in the ink layer 20. The ultrasonic fingerprint module 100 has the OD value of 6.1.

A ninth implementation is provided, which is different from the eighth implementation in that, the mass ratio of the carbon powder in the ink layer 20 is reduced, and the mass ratio of the anti-foaming agent in the ink layer 20 is increased. Specifically, the carbon powder has the mass ratio of 10% in the ink layer 20. The anti-foaming agent in the ink layer 20 is modified dimethyl silane. The anti-foaming agent has the mass ratio of 0.8% in the ink layer 20. After the molding material of the ink layer 20 with the anti-foaming agent added is stirred, there are a small number of bubbles. After the stirred molding material of the ink layer 20 is printed and molded on the ultrasonic detecting layer 10 through the screen printing process, there are still a small number of bubbles in the ink layer 20. The ultrasonic fingerprint module 100 has the OD value of 5.3. It can be seen that, when the mass ratio of the carbon powder in the ink layer 20 is higher, it is easier to generate bubbles in a preparation process of the ink layer 20. By reducing the mass ratio of the carbon powder in the ink layer 20 and increasing the mass ratio of anti-foaming agent in the ink layer 20, a bubble content in the ink layer 20 can be improved.

A tenth implementation is provided, which is different from the ninth implementation in that, the mass ratio of the carbon powder in the ink layer 20 is further reduced, and the mass ratio of the anti-foaming agent in the ink layer 20 is further increased. Specifically, the carbon powder has the mass ratio of 5% in the ink layer 20. The anti-foaming agent in the ink layer 20 is modified dimethyl silane. The anti-foaming agent has the mass ratio of 1.5% in the ink layer 20. After the molding material of the ink layer 20 with the anti-foaming agent added is stirred, there are a very small number of bubbles. After the stirred molding material in the ink layer 20 is printed and molded on the ultrasonic detecting layer 10 through the screen printing process, there are still a very small number of bubbles in the ink layer 20. The ultrasonic fingerprint module 100 has the OD value of 4.6. It can be seen that, by reducing the mass ratio of the carbon powder in the ink layer 20 and increasing the mass ratio of the anti-foaming agent in the ink layer 20, a bubble content in the ink layer 20 can be obviously improved, however, the OD value of the ultrasonic fingerprint module 100 can be obviously reduced at the same time, which will easily lead to performance degradation of the ultrasonic fingerprint module 100.

An eleventh implementation is provided, which is different from the tenth implementation in that, the mass ratio of the carbon powder in the ink layer 20 is further reduced, and the mass ratio of the anti-foaming agent in the ink layer 20 is further increased. Specifically, the carbon powder has the mass ratio of 2.5% in the ink layer 20. The anti-foaming agent in the ink layer 20 is modified dimethyl silane. The anti-foaming agent has the mass ratio of 2.0% in the ink layer 20. After the molding material of the ink layer 20 with the anti-foaming agent added is stirred, there are a very small number of bubbles. After the stirred molding material in the ink layer 20 is printed and molded on the ultrasonic detecting layer 10 through the screen printing process, there are still a very small number of bubbles in the ink layer 20. The ultrasonic fingerprint module 100 has the OD value of 3.7. When the anti-foaming agent has the mass ratio of 2.0% in the ink layer 20, the ink layer 20 has obvious shrinkage holes. It can be seen that, when the anti-foaming agent has the mass ratio greater than 2.0% in the ink layer 20, the ink layer 20 cannot meet usage requirements. Only if the mass ratio of the carbon powder in the ink layer 20 is greater than or equal to 5%, and the mass ratio of the anti-foaming agent in the ink layer 20 is increased to about 1.5%, can the OD value of the ultrasonic fingerprint module 100 meet minimum requirements. However, it is still impossible to ensure that there are no bubbles in the ink layer 20.

A twelfth implementation is provided, which is different from the eleventh implementation in that, the ink layer 20 includes two different types of anti-foaming agents. Specifically, the carbon powder has the mass ratio of 5% in the ink layer 20. The anti-foaming agent in the ink layer 20 is a mixture of modified dimethyl silane and polyoxypropylene oxyethylene glycerol ether. Modified dimethyl silane has the mass ratio of 1.5% in the ink layer 20. Polyoxypropylene oxyethylene glycerol ether has the mass ratio of 0.2% in the ink layer 20. After the molding material of the ink layer 20 with the anti-foaming agent added is stirred, there are no bubbles. After the stirred molding material in the ink layer 20 is printed and molded on the ultrasonic detecting layer 10 through the screen printing process, there are still a very small number of bubbles in the ink layer 20. The ultrasonic fingerprint module 100 has the OD value of 4.5. It can be seen that, by including modified dimethyl silane and polyoxypropylene oxyethylene glycerol ether in the anti-foaming agent of the ink layer 20, a bubble content in the ink layer 20 can be obviously improved during a preparation process, and the OD value of the ultrasonic fingerprint module 100 can also meet the performance requirements. However, there are still a very small number of bubbles in a finally molded ink layer 20.

A thirteenth implementation is provided, which is different from the eleventh implementation in that, the mass ratio of polyoxypropylene oxyethylene glycerol ether in the molding material of the ink layer 20 is increased. Specifically, the carbon powder has the mass ratio of 5% in the ink layer 20. The anti-foaming agent in the ink layer 20 is a mixture of modified dimethyl silane and polyoxypropylene oxyethylene glycerol ether. Modified dimethyl silane has the mass ratio of 1.5% in the ink layer 20. Polyoxypropylene oxyethylene glycerol ether has the mass ratio of 0.5% in the ink layer 20. After the molding material of the ink layer 20 with the anti-foaming agent added is stirred, there are no bubbles. After the stirred molding material in the ink layer 20 is printed and molded on the ultrasonic detecting layer 10 through the screen printing process, there are no bubbles in the ink layer 20. The ultrasonic fingerprint module 100 has the OD value of 4.6. It can be seen that, by including modified dimethyl silane and polyoxypropylene oxyethylene glycerol ether in the anti-foaming agent of the ink layer 20, and increasing the mass of polyoxypropylene oxyethylene glycerol ether, there are no bubbles during a preparation process of the ink layer 20, and there are no bubbles in a finally molded ink layer 20, and the OD value of the ultrasonic fingerprint module 100 also meets performance requirements, such that performance of the ultrasonic fingerprint module 100 is obviously improved.

A fourteenth implementation is provided, which is different from the eleventh implementation in that, the mass ratio of polyoxypropylene oxyethylene glycerol ether in the ink layer 20 is further increased. Specifically, the carbon powder has the mass ratio of 5% in the ink layer 20. The anti-foaming agent in the ink layer 20 is a mixture of modified dimethyl silane and polyoxypropylene oxyethylene glycerol ether. Modified dimethyl silane has the mass ratio of 1.5% in the ink layer 20. Polyoxypropylene oxyethylene glycerol ether has the mass ratio of 1.0% in the ink layer 20. After the molding material of the ink layer 20 with the anti-foaming agent added is stirred, there are no bubbles. After the stirred molding material in the ink layer 20 is printed and molded on the ultrasonic detecting layer 10 through the screen printing process, there are no bubbles in the ink layer 20. The ultrasonic fingerprint module 100 has the OD value of 4.6.

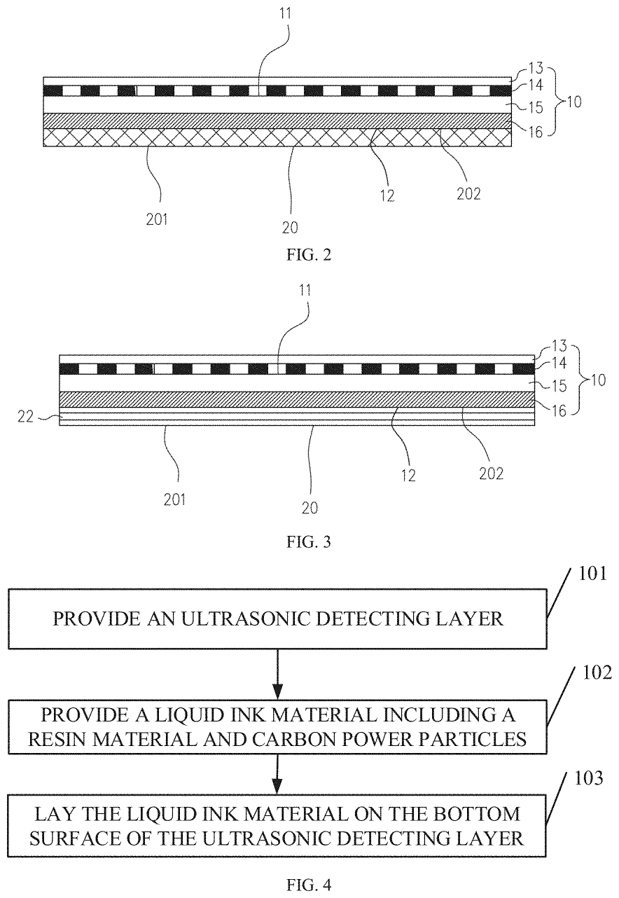

Furthermore, reference can be made to FIG. 2, the ultrasonic detecting layer 10 includes a substrate layer 13, multiple pixel electrodes 14, a piezoelectric layer 15, and a conductive electrode 16. The multiple pixel electrodes 14 are arranged on the substrate layer 13 in an array, the piezoelectric layer 15 is configured to cover the multiple pixel electrodes 14, the conductive electrode 16 is stacked on a surface of the piezoelectric layer 15 away from the multiple pixel electrodes 14, and the ink layer 20 is printed and molded on a surface of the conductive electrode 16 away from the piezoelectric layer 15.

In this implementation, the substrate layer 13 may be made of glass or a polyimide film material. The substrate layer 13 has low cost and great light transmittance property, which facilitates integration of the ultrasonic fingerprint module 100 into the display screen of the electronic device. When the ultrasonic fingerprint module 100 is integrated into the display screen, the ultrasonic fingerprint module 100 with great light transmittance property will not block a displayed image of the display screen 90, and at the same time, the ultrasonic fingerprint module 100 integrated into the display screen 90 can keep overall color of the display screen 90 consistent, thereby improving appearance performance of the display screen 90.

In this implementation, the multiple pixel electrodes 14 may be molded on the substrate layer 13 through a TFT printing process and are distributed in an array. The multiple pixel electrodes 14 are made of any one of indium tin oxide (ITO), Ag nanowire, metal mesh, carbon nanotube, and graphene. The multiple pixel electrodes 14 made of the above materials have great toughness and light transmittance property, such that the ultrasonic fingerprint module 100 made of the multiple pixel electrodes 14 has great toughness and light transmittance property. Light transmittance of the multiple pixel electrodes 14 is greater than 90%, such that the ultrasonic fingerprint module 100 made of the multiple pixel electrodes 14 has great light transmittance property. The multiple pixel electrodes 14 can be configured to receive electrical signals, and each of the multiple pixel electrodes 14 can be configured to determine a position of the ultrasonic fingerprint module 100 according to the received electrical signals. Density of the multiple pixel electrodes 14 on the substrate layer 13 is positively related to fingerprint collection accuracy of the ultrasonic fingerprint module 100. Intensiveness of the multiple pixel electrodes 14 arranged in an array ensures accuracy of a fingerprint image of an object to be detected which is detected by an ultrasonic sensor.

In this implementation, the ultrasonic receiving surface 11 is disposed on a side of the piezoelectric layer 15 facing the substrate layer 13. The piezoelectric layer 15 is stacked on the substrate layer 13 and covers the multiple pixel electrodes 14. The piezoelectric layer 15 has a sheet structure made of a piezoelectric material. A shape of the piezoelectric layer 15 matches a shape of the substrate layer 13. The piezoelectric layer 15 is made of polyvinylidene fluoride (PVDF). Because PVDF has great toughness and light transmittance property, the piezoelectric layer 15 has great flexibility and light transmittance property, which ensures the flexibility and light transmittance property of the ultrasonic fingerprint module 100. The piezoelectric layer 15 can be configured to generate ultrasonic waves under action of high-frequency voltage (for example, voltage with frequency greater than 20 kilohertz (kHz)). After the piezoelectric layer 15 receives the ultrasonic waves reflected by the object to be detected, the piezoelectric layer 15 will generate electric signals (or piezoelectric signals) under action of the ultrasonic waves. The object to be detected may be a finger, a test template, etc.

In this implementation, the conductive electrode 16 has an integral layered structure made of a conductive material. A shape of the conductive electrode 16 matches the shape of the piezoelectric layer 15. The conductive electrode 16 may be made of silver. The conductive electrode 16 may be molded by silver paste curing. The light transmittance of the conductive electrode 16 is greater than 90%. After a high-frequency voltage is applied to the conductive electrode 16 and the pixel electrode 14, the conductive electrode 16 and the pixel electrode 14 can be configured to apply high-frequency voltage to the piezoelectric layer 15, such that the piezoelectric layer 15 can generate ultrasonic signals to facilitate detection of the user's finger through the ultrasonic signals. The conductive electrode 16 and the multiple pixel electrodes 14 can also be configured to receive electrical signals generated by the piezoelectric layer 15. The bottom surface of the ultrasonic detecting layer 12 is disposed on a surface of the conductive electrode 16 away from the piezoelectric layer 15. The ink layer 20 is configured to cover the conductive electrode 16 to prevent the conductive electrode 16 from oxidation. The ink layer 20 can also be configured to cover an appearance defect on the conductive electrode 16.

In this implementation, the conductive electrode 16 has a thickness of 10 μm to 30 μm, the piezoelectric layer 15 has the thickness of 5 μm to 15 μm, the substrate layer 13 has the thickness of 80 μm to 100 μm, and the ink layer 20 has the thickness of 7 μm to 30 μm. Slimness performance of the ultrasonic fingerprint module 100 facilitates integration of the ultrasonic fingerprint module 100 into the display screen of electronic device.

It can be understood that, the ink layer 20 is printed and molded on the ultrasonic detecting layer 10, that is, the ink layer 20 is printed and molded on the conductive electrode 16. The surface roughness of the conductive electrode 16 has an influence on the roughness of the first surface 201 of the ink layer 20.

During testing, the ink layers 20 with different thicknesses are molded on a glass substrate with low surface roughness, the surface roughness of a molded ink layer 20 is measured, and it is found that the surface roughness of the molded ink layer 20 is not greatly affected by the thickness of the ink layer 20. For example, ink layers 20 with film thicknesses of 5 μm, 10 μm, 15 μm, 20 μm, 25 μm, and 30 μm are respectively molded on the glass substrate, and the surface roughness of molded ink layers 20 are 0.375 Rz/μm, 0.355 Rz/μm, 0.335 Rz/μm, 0.315 Rz/μm, 0.316 Rz/μm, and 0.322 Rz/μm respectively.

During testing, multiple ink layers 20 with different thicknesses are respectively molded on multiple ultrasonic detecting layers 10, and finally multiple ultrasonic fingerprint modules 100 are obtained. By measuring the surface roughness of the ink layers 20 of the ultrasonic fingerprint modules 100, it is found that as the ink layer 20 becomes thicker, the surface roughness of the ink layer 20 becomes lower, and when the ink layer 20 has the thickness of approximately 25 μm, the surface roughness of the ink layer 20 is not reduced with reduction of the thickness of the ink layer 20, that is, the surface roughness of the ink layer 20 tends to be stable and is not reduced.

In an implementation, the surface roughness of six ultrasonic detecting layers 10 facing the ink layer 20 are set to be 3.5 Rz/μm to 4.5 Rz/μm. In the six ultrasonic detecting layers 10, the substrate layer 13 has the thickness of 90 μm, the piezoelectric layer 15 has the thickness of 9 μm, and the conductive electrode 16 has the thickness of 15 μm to 18 μm. Six ink layers 20 with the film thicknesses of 5 μm, 10 μm, 15 μm, 20 μm, 25 μm, and 30 μm are respectively molded on the six ultrasonic detecting layers 10, and the surface roughness of six molded ink layers 20 are detected to be 1.712 Rz/μm, 1.06 Rz/μm, 0.72 Rz/μm, 0.527 Rz/μm, 0.309 Rz/μm, and 0.324 Rz/μm respectively. Apparently, when the ink layer 20 has the thickness of 20 μm to 30 μm, the ink layer 20 of the ultrasonic fingerprint module 100 has low surface roughness, and the ultrasonic fingerprint module 100 has excellent performance.

In another implementation, as illustrated in FIG. 3, the ink layer 20 has multiple sub ink layers 22, and the multiple sub ink layers are stacked in sequence.

In this implementation, the ink layer 20 is molded by multiple printing operations, and each of the multiple sub ink layers 22 is formed by each of the multiple printing operations. After each of the multiple sub ink layers 22 is cured to form, another sub ink layer 22 is formed. The thickness of each of the multiple sub ink layers 22 can be set to be the same. By accurately controlling the surface roughness of each of the multiple sub ink layers 22, a finally molded ink layer 20 can have more excellent surface roughness, so as to ensure that the ultrasonic fingerprint module 100 has excellent performance.

Reference can be made to FIG. 4, a manufacturing method of an ultrasonic fingerprint module is provided in the present disclosure, and the manufacturing method includes the following operations.

101, an ultrasonic detecting layer 10 is provided.

In this implementation, firstly, a substrate layer 13 is molded. The substrate layer 13 may be made of glass or a polyimide film material. The substrate layer 13 has great mechanical strength, which facilitates molding of other structural components on the substrate layer 13, and a stable connection between the ultrasonic fingerprint module 100 and a housing of an electronic device or a back surface of a display screen of the electronic device. Length and width dimensions of the substrate layer 13 can be determined according to required length and width design dimensions of the ultrasonic fingerprint module 100, such that the length and width dimensions of a manufactured ultrasonic fingerprint module 100 can meet specification requirements.

Then, a pixel electrode layer is molded on the substrate layer 13. The pixel electrode layer includes multiple pixel electrodes 14. Length and width dimensions of the pixel electrode layer are substantially the same as those of the substrate layer 13. The multiple pixel electrodes 14 of the pixel electrode layer can be molded on the substrate layer 13 through a TFT printing process. The multiple pixel electrodes 14 are made of any one of ITO, Ag nanowire, metal mesh, carbon nanotube, and graphene. The multiple pixel electrodes 14 made of the above materials have great toughness and light transmittance property.

Then, a piezoelectric layer 15 is molded on the pixel electrode layer. The length and width dimensions of the piezoelectric layer 15 are substantially the same as those of the pixel electrode layer. The piezoelectric layer 15 covers the multiple pixel electrodes 14. The piezoelectric layer 15 has a sheet structure made of a piezoelectric material. A shape of the piezoelectric layer 15 matches a shape of the substrate layer 13. The piezoelectric layer 15 is made of PVDF. Because PVDF has great toughness and light transmittance property, the piezoelectric layer 15 has great flexibility and light transmittance property, which ensures the flexibility and light transmittance property of the ultrasonic fingerprint module 100.

Then, a conductive electrode 16 is molded on the piezoelectric layer 15. The length and width dimensions of the conductive electrode 16 are the same as those of the pixel electrode layer, such that the conductive electrode 16 matches the pixel electrode layer. The conductive electrode 16 may be molded on the piezoelectric layer 15 through a screen printing process. The conductive electrode 16 has an integral layered structure made of a conductive material. A shape of the conductive electrode 16 matches a shape of the piezoelectric layer 15. The conductive electrode 16 may be made of silver. The conductive electrode 16 may be molded by silver paste curing. Two or more layers of conductive electrodes 16 can be molded on the piezoelectric layer 15, such that the surface roughness of an outermost conductive electrode 16 away from the piezoelectric layer 15 is lower, that is, a bottom surface of the ultrasonic detecting layer 10 is smoother.

102, a liquid ink material including a resin material and carbon powder particles is provided.

In this implementation, the resin material may be any one of or a combination of more than one of: acrylic resin, polyester resin, isocyanate resin, phenoxy resin, and epoxy resin. As a preferable implementation, the liquid ink material is formed by mixing and stirring epoxy resin and the carbon powder particles.

Furthermore, the liquid ink material further includes an anti-foaming agent and a leveling agent. That is, the liquid ink material is formed by mixing and stirring epoxy resin, the carbon powder particles, the anti-foaming agent, and the leveling agent.

The liquid ink material includes the anti-foaming agent, which can effectively reduce the number of bubbles in the ink layer 20 and improve reflection efficiency of the ink layer 20 to ultrasonic waves. The anti-foaming agent may be modified dimethyl silane, or polyoxypropylene ethylene glycol ether, or a mixed anti-foaming agent of modified dimethyl silane and polyoxypropylene ethylene glycol ether. The anti-foaming agent has a mass ratio of 1.0% to 3.0%. As a preferable implementation, the anti-foaming agent has the mass ratio of 1.5% to 2.5%. When the anti-foaming agent has the mass ratio of 1.5%, the stirred liquid ink material may have a small number of bubbles, and the ink layer 20 which is formed after the liquid ink material is cured may also have a small number of bubbles, such that the ultrasonic fingerprint module 100 can meet fingerprint recognition requirements. When the anti-foaming agent has the mass ratio of 2.5%, bubbles in the stirred liquid ink material can be effectively eliminated, the ink layer 20 which is formed after the liquid ink material is cured can also be free of bubbles, and the ultrasonic fingerprint module 100 provided with the ink layer 20 has excellent performance and great fingerprint recognition efficiency.

The liquid ink material includes the leveling agent, which can effectively reduce surface roughness of the ink layer 20 and improve the reflection efficiency of the ink layer 20 to ultrasonic waves. The leveling agent may be fluorocarbon organic modified siloxane, or polyether siloxane copolymer, or a mixed leveling agent of fluorocarbon organic modified siloxane and polyether siloxane copolymer. The leveling agent has the mass ratio of 0.2% to 1.5%. As a preferable implementation, the leveling agent has the mass ratio of 0.5% to 1.0%. When the leveling agent has the mass ratio of 0.5%, a surface of the ink layer 20 which is formed after the liquid ink material is cured is smooth, and the surface roughness of the ink layer 20 can be controlled to 0.6 Rz/μm. When the leveling agent has the mass ratio of 1.0%, the surface roughness of the ink layer 20 which is formed after the liquid ink material is cured can be controlled to be 0.4 Rz/μm, such that ultrasonic recognition efficiency of the ultrasonic fingerprint module 100 is effectively improved.

103, the liquid ink material is laid on the bottom surface of the ultrasonic detecting layer 10, where the liquid ink material is cured to form the ink layer 20, and the ink layer 20 covers the ultrasonic receiving surface of the ultrasonic detecting layer 10.

In this implementation, a surface of the outermost conductive electronic 16 away from the piezoelectric layer 15 forms the bottom surface of ultrasonic detecting layer 10. The liquid ink material can be molded on the conductive electrode 16 through vacuum evaporation, screen printing, spraying, sputtering, or other processes.

In another implementation, the substrate layer 13 can be processed with the length and width dimensions being equal to at least n times the length and width design dimensions of a required ultrasonic fingerprint module 100, which facilitates molding of the pixel electrode layer, the piezoelectric layer 15, the conductive electrode 16, and the ink layer 20 all with large area on the substrate layer 13 in sequence, and facilitates obtaining of multiple ultrasonic fingerprint modules 100 in batches through cutting processing. The pixel electrode layer 15, the piezoelectric layer 15, the conductive electrode 16, and the ink layer 20 can be processed and molded according to multiple preset array arrangement regions of the ultrasonic fingerprint modules 100, such that manufacturing costs of obtaining multiple ultrasonic fingerprint modules 100 in batches can be reduced.

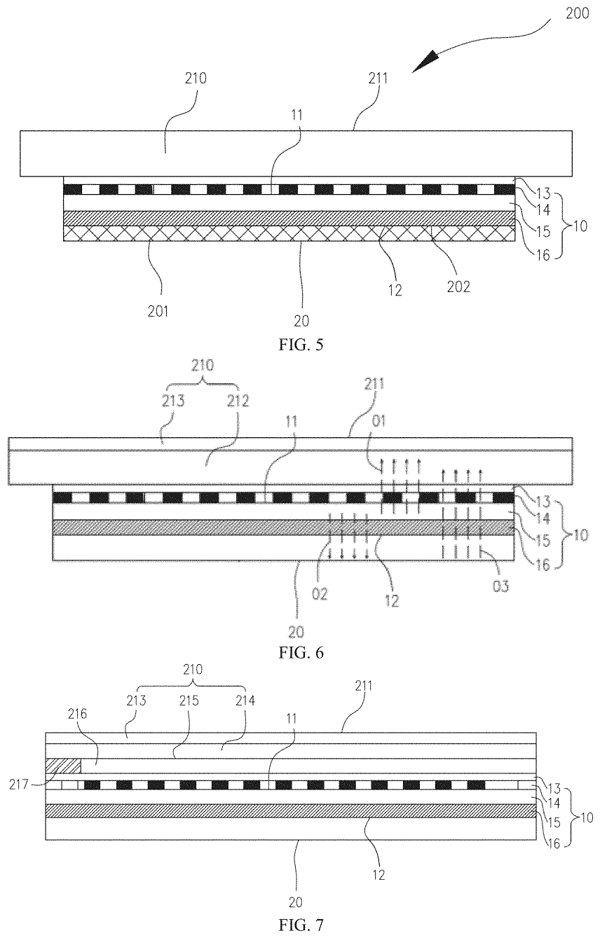

Reference can be made to FIG. 5, a display screen assembly 200 is also provided in the present disclosure. The display screen assembly 200 includes a display screen 210 and an ultrasonic fingerprint module 100. The display screen 210 has an outer surface 211 facing a user, the ultrasonic fingerprint module 100 is fixed in or under the display screen 210, and the ink layer 20 is away from the outer surface 211 relative to the ultrasonic detecting layer 10.

Reference can be made to FIG. 6, in an implementation, an ink layer 20 of an ultrasonic fingerprint module 100 is impenetrable to visible light. The ultrasonic fingerprint module 100 is fixed under a display screen 210, and the ink layer 20 is configured to prevent display light of the display screen 210 from being emitted from a surface away from an outer surface 211.

Specifically, the display screen 210 includes an organic electroluminescent (i.e., light-emitting) layer 212, and the ultrasonic detecting layer 10 is stacked on a surface of the organic electroluminescent layer 212 away from the outer surface 211. The display screen 210 includes a glass cover plate 213. The glass cover plate 213 has the outer surface 211. The organic electroluminescent layer 212 is attached to the glass cover plate 213. A substrate layer 13 of the ultrasonic detecting layer 10 is attached to the organic electroluminescent layer 212. The substrate layer 13 can constitute a base layer of the organic electroluminescent layer 212. The substrate layer 13 can be attached to the organic electroluminescent layer 212 through an adhesive layer. The display screen 210 is an organic light-emitting diode (OLED) display screen 210. With the aid of an impenetrable property of the ink layer 20 of the ultrasonic fingerprint module 100, the ink layer 20 can function as a back plate of the display screen 210, which facilitates image display of the display screen 210. The display screen 210 may be a flexible display screen. The ultrasonic fingerprint module 100 can deform with bending of the display screen 210.

It can be understood that, by setting a distance from the outer surface 211 to a surface of the ultrasonic detecting layer 10 attached to the ink layer 20, and by setting frequencies of ultrasonic waves emitted from the ultrasonic detecting layer 10, the piezoelectric layer 15 of the ultrasonic detecting layer 10 emits first ultrasonic signals 01 toward the outer surface 211 and emit second ultrasonic signals 02 toward the ink layer 20. The second ultrasonic signals 02 are reflected by an interface where the ink layer 20 is in contact with air to form third ultrasonic signals 03. The third ultrasonic signals 03 are also emitted toward the outer surface 211. The third ultrasonic signals 03 can resonate with the first ultrasonic signals 01, and the third ultrasonic signals 03 and the first ultrasonic signals 01 are emitted together toward the outer surface 211 to improve fingerprint recognition efficiency.

During testing, six display screen assemblies 200 are provided, and thicknesses of ink layers 20 of six display screen assemblies 200 are different from each other, SNR values of the ultrasonic fingerprint modules 100 in six display screen assemblies 200 are compared, and resolution (e.g., LPMM) values of fingerprint images obtained by the ultrasonic fingerprint modules 100 in six display screen assemblies 200 are compared. For example, the thicknesses of the ink layers 20 of six display screen assemblies 200 are 5 μm, 10 μm, 15 μm, 20 μm, 25 μm, and 30 μm respectively, the SNR values of the ultrasonic fingerprint modules 100 in six display screen assemblies 200 are tested to be 4.571, 4.9, 5.308, 5.859, 6.105, and 5.72, respectively, and the resolution (e.g., LPMM) values of fingerprint images obtained by the ultrasonic fingerprint modules 100 in the six display screen assemblies 200 are 3.23, 3.32, 3.421, 3.594, 3.593, and 3.6, respectively. It can be seen that, when the ink layer 20 has the thickness of 25 μm, the ultrasonic fingerprint module 100 of the display screen assembly 200 has excellent performance. That is, as a preferable implementation, the thickness of the ink layer 20 of the ultrasonic fingerprint module 100 can be set to be within 20 μm˜30 μm.

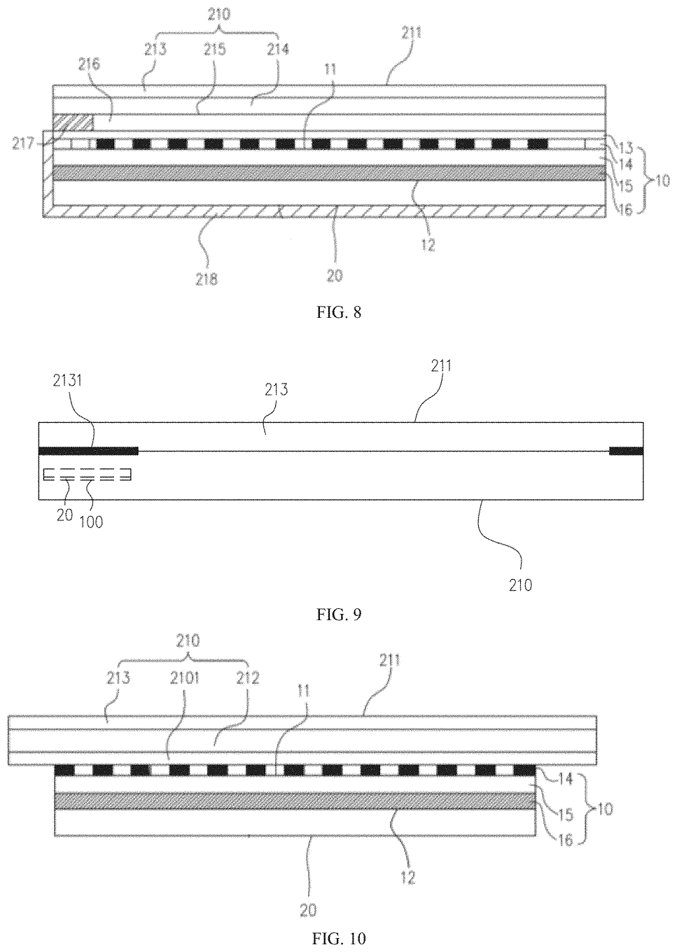

Reference can be made to FIG. 7 and FIG. 8, and this implementation is substantially the same as the implementations illustrated in FIG. 6, except the followings. A display screen 210 is provided with a liquid crystal panel 214 and a backlight module 215, the backlight module 215 includes a backlight light guide plate 216 attached to the liquid crystal panel 214 and a backlight 217 fixed to a side of the backlight light guide plate 216. An ultrasonic detecting layer 10 is attached to a surface of the backlight light guide plate 216 away from the liquid crystal panel 214. The liquid crystal panel 214 is attached to the glass cover plate 213. A substrate layer 13 is attached to the backlight light guide plate 216. The substrate layer 13 can function as a base layer of the backlight light guide plate 216. Because the ink layer 20 is impenetrable, the ink layer 20 can function as a back plate of the backlight module 215, the liquid crystal panel 214 can obtain light of the backlight module 215, thereby displaying images. In order to improve structural stability of the backlight module 215, the backlight module 215 further includes an encapsulation bottom plate 218, the encapsulation bottom plate 218 is configured to encapsulate the backlight 217 and the backlight light guide plate 216, and an ultrasonic fingerprint module 100 is fixed between the backlight light guide plate 216 and the encapsulation bottom plate 218. The encapsulation bottom plate 218 is configured to protect the ultrasonic fingerprint module 100, and also encapsulate the backlight 217 to prevent the backlight 217 from leaking light. The encapsulation bottom plate 218 may be a bendable metal plate. An assembly gap exists between the encapsulation bottom plate 218 and the ultrasonic fingerprint module 100, so as to increase an ultrasonic blocking rate of the ink layer 20 and ensure effectiveness of the ultrasonic fingerprint module 100 in fingerprint recognition.

Reference can be made to FIG. 9, and this implementation is substantially the same as the implementations illustrated in FIG. 6, except the followings. An ultrasonic fingerprint module 100 can be embedded in a display screen 210, and the ultrasonic fingerprint module 100 is located in a non-display region of the display screen 210. Specifically, a glass cover plate 213 has a non-light-transmitting region 2131. The non-light-transmitting region 2131 of the glass cover plate 213 is composed of an ink layer attached to glass. The non-light-transmitting region 2131 of the glass cover plate 213 is configured to cover the ultrasonic fingerprint module 100, so as to ensure appearance performance of a display screen assembly 200. The ultrasonic fingerprint module 100 is disposed at the non-display region of the display screen assembly 200, so as to prevent an ink layer 20 of the ultrasonic fingerprint module 100 from blocking displaying light, and ensure displaying effect of a display region of the display screen assembly 200. A gap exists between the ink layer 20 of the ultrasonic fingerprint module 100 and other layer structures of the display screen assembly 200, so as to ensure blocking efficiency of the ink layer 20 to ultrasonic waves, and ensure fingerprint recognition effectiveness of the ultrasonic fingerprint module 100.

Reference can be made to FIG. 10, and this implementation is substantially the same as the implementations shown in FIG. 7, except the followings. A display screen 210 has a substrate 2101 attached to an organic electroluminescent layer 212, an ultrasonic detecting layer 10 includes multiple pixel electrodes 14, a piezoelectric layer 15, and a conductive electrode 16. The multiple pixel electrodes 14 are arranged in an array on a surface of the substrate 2101 away from a glass cover plate 213, the piezoelectric layer 15 covers the multiple pixel electrodes 14, the conductive electrode 16 is stacked on a surface of the piezoelectric layer 15 away from the multiple pixel electrodes 14, and an ink layer 20 is printed and molded on a surface of the conductive electrode 16 away from the piezoelectric layer 15. That is, an ultrasonic fingerprint module 100 is attached to the substrate 2101 of the display screen 210. Of course, in other implementations, the display screen 210 is provided with the substrate 2101 of a liquid crystal panel 214, and the multiple pixel electrodes 14 of the ultrasonic fingerprint module 100 can be molded on the substrate 2101 of the liquid crystal panel 214.

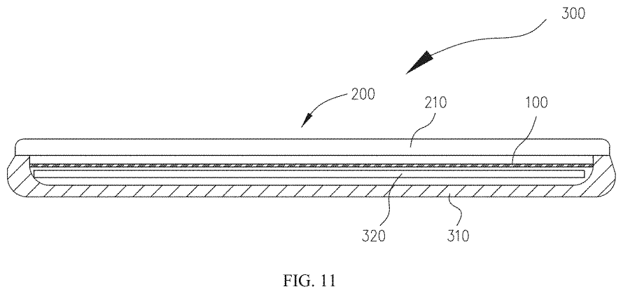

Reference can be made to FIG. 11, an electronic device 300 is also provided in the present disclosure. The electronic device 300 includes a display screen assembly 200, a back cover 310 and a main board 320. A display screen 210 covers the back cover 310. The main board 320 is fixed between the back cover 310 and the display screen 210, and the main board 320 is electrically connected with the display screen 210 and an ultrasonic fingerprint module 100. The main board 320 can be configured to receive electrical signals of the ultrasonic fingerprint module 100 to recognize a user's fingerprint image. It can be understood that, the ultrasonic fingerprint module 100 can be configured to receive fingerprint detecting signals which have been reflected by the user's fingerprint, and the fingerprint detecting signals which have been reflected by the user's fingerprint may be generated by initial detecting signals emitted from the ultrasonic fingerprint module 100 propagating to the user's fingerprint, or the initial detecting signals emitted from an external ultrasonic signal source propagating to the user's fingerprint. The electronic device 300 may be a mobile phone, a tablet computer, a notebook computer, a media player, etc., or a financial terminal device such as an ATM. The ultrasonic fingerprint module 100 is disposed in the display screen 210, such that the electronic device 300 can meet diversified fingerprint recognition requirements and fingerprint recognition efficiency can be improved.

It can be understood that, any specific value with protective significance in the implementations is not limited to the specific value provided above, and other values similar to the specific value provided in the implementations are also within the protection scope of the implementations of the present application.

The above are the preferable implementations of the present disclosure. It should be noted that, for those of ordinary skill in the art, without departing from a concept of the present disclosure, several modifications and improvements can be made, and these modifications and improvements all fall within the protection of scope of the present disclosure.

What is claimed is:

1. An ultrasonic fingerprint module, comprising:
an ultrasonic detecting layer having an ultrasonic receiving surface; and
an ink layer disposed on a surface of the ultrasonic detecting layer away from the ultrasonic receiving surface, wherein the ink layer is configured to reflect ultrasonic waves emitted from the ultrasonic detecting layer, the ink layer comprises carbon powder particles, and the carbon powder particles have an average particle size of 0.5 micrometer (μm) to 5 μm and have a mass ratio of 2.5% to 15%.

2. The ultrasonic fingerprint module of claim 1, wherein the carbon powder particles have the average particle size of 0.8 μm to 2 μm.

3. The ultrasonic fingerprint module of claim 2, wherein the carbon powder particles have the average particle size of 1.0 μm.

4. The ultrasonic fingerprint module of claim 1, wherein the carbon powder particles have the mass ratio of 3.0% to 10% in the ink layer.

5. The ultrasonic fingerprint module of claim 4, wherein the carbon powder particles have the mass ratio of 5% in the ink layer.

6. The ultrasonic fingerprint module of claim 1, wherein the ink layer comprises a resin material.

7. The ultrasonic fingerprint module of claim 6, wherein the resin material comprises any one of or a combination of more than one of: acrylic resin, polyester resin, isocyanate resin, phenoxy resin, and epoxy resin.

8. The ultrasonic fingerprint module of claim 7, wherein the resin material is epoxy resin with a chemical abstracts service (CAS) number of 38891-59-7.

9. The ultrasonic fingerprint module of claim 1, wherein the ink layer is provided with a leveling agent, and the leveling agent is configured to improve a surface leveling property of the ink layer during a manufacturing process and improve the surface leveling property of a finally formed ink layer.

10. The ultrasonic fingerprint module of claim 1, wherein the ink layer is provided with an anti-foaming agent, and the anti-foaming agent is configured to eliminate bubbles in the ink layer during a manufacturing process and eliminate bubbles in a finally formed ink layer.

11. The ultrasonic fingerprint module of claim 1, wherein the ultrasonic detecting layer comprises a substrate layer, a pixel electrode layer, a piezoelectric layer, and a conductive electrode which are stacked in sequence, and the ink layer is disposed on a surface of the conductive electrode away from the piezoelectric layer.

12. The ultrasonic fingerprint module of claim 1, wherein the ink layer has a thickness of 5 μm to 30 μm.

13. The ultrasonic fingerprint module of claim 12, wherein the ink layer has the thickness of 20 μm to 30 μm.

14. The ultrasonic fingerprint module of claim 13, wherein the ink layer has the thickness of 25 μm.

15. A manufacturing method of an ultrasonic fingerprint module, comprising:
providing an ultrasonic detecting layer, wherein the ultrasonic detecting layer has an ultrasonic receiving surface and a bottom surface of the ultrasonic detecting layer disposed opposite to the ultrasonic receiving surface;
providing a liquid ink material comprising carbon powder particles, wherein the carbon powder particles have an average particle size of 0.5 micrometer (μm) to 5 μm, and have a mass ratio of 2.5% to 15% in the liquid ink material; and
laying the liquid ink material on the bottom surface of the ultrasonic detecting layer, wherein the liquid ink material is cured to form an ink layer, and the ink layer covers the ultrasonic receiving surface of the ultrasonic detecting layer.

16. The manufacturing method of claim 15, wherein the liquid ink material further comprises a resin material, a leveling agent, and an anti-foaming agent, and the liquid ink material is formed by mixing and stirring the resin material, the carbon powder particles, the leveling agent, and the anti-foaming agent.

17. The manufacturing method of claim 15, wherein the carbon powder particles have the average particle size of 0.8 μm to 2 μm.

18. The manufacturing method of claim 15, wherein the carbon powder particles have the mass ratio of 3.0% to 10% in the ink layer.

19. The manufacturing method of claim 15, wherein providing the ultrasonic detecting layer comprises:
molding a substrate layer, a pixel electrode, a piezoelectric layer, and a conductive electrode which are stacked in sequence; and
forming the bottom surface of the ultrasonic detecting layer on a surface of the conductive electrode away from the piezoelectric layer.

20. An electronic device, comprising an ultrasonic fingerprint module, wherein the ultrasonic fingerprint module comprises:
an ultrasonic detecting layer having an ultrasonic receiving surface; and
an ink layer disposed on a surface of the ultrasonic detecting layer away from the ultrasonic receiving surface, wherein the ink layer is configured to reflect ultrasonic waves emitted from the ultrasonic detecting layer, the ink layer comprises carbon powder particles, and the carbon powder particles have an average particle size of 0.5 micrometer (μm) to 5 μm and have a mass ratio of 2.5% to 15%.
